(19) United States
(12) Patent Application Publication
(10) Pub. No.: US 2013/0234488 A1
(43) Pub. Date: Sep. 12, 2013

(54) LOCKING DEVICE, ADJUSTMENT DEVICE, MOTOR VEHICLE SEAT, MOTOR VEHICLE AS WELL AS RELATED METHOD

(71) Applicant: GM GLOBAL TECHNOLOGY OPERATIONS LLC, Detroit, MI (US)

(72) Inventor: Andrzej PLESKOT, Trebur (DE)

(73) Assignee: GM Global Technology Operations LLC, Detroit, MI (US)

(21) Appl. No.: 13/777,148

(22) Filed: Feb. 26, 2013

(30) Foreign Application Priority Data
Mar. 12, 2012 (DE) 10 2012 004 695.2

(51) Int. Cl. B60N 2/22

(52) U.S. Cl. CPC B60N 2/22
USPC 297/354.12; 29/428

(57) ABSTRACT

A locking device for an adjustment device for adjusting a motor vehicle seat is provided. The locking device includes an adjustable fitting and an adapter unit that joins the adjustable fitting with a seat part and a backrest that is adjustable in relation to the seat part so as to release and/or block an adjustment of the backrest relative to the seat part. A backrest force element interacts with the backrest to expose the backrest to a force at least with the locking device in an unlocked state. The backrest force element is arranged on an interior side of the locking device. An adjustment device, a motor vehicle seat, a motor vehicle, and a method for manufacturing the locking device also are provided.

### CROSS-REFERENCE TO RELATED APPLICATION

This application claims priority to German Patent Application No. 10 2012 004 695.2, filed Mar. 12, 2012, which is incorporated herein by reference in its entirety.

### TECHNICAL FIELD

The technical field relates to a locking device for an adjustment device for adjusting a motor vehicle seat, an adjustment device for adjusting a motor vehicle seat, a motor vehicle seat, a motor vehicle, and a method for manufacturing the locking device.

### BACKGROUND

Known from prior art are motor vehicles with seats in which a backrest or backrest part or the position of the backrest can be adjusted, in particular in relation to a seat part. The adjustment takes place by way of a lever mechanism arranged on the seat or another actuating device secured there. Known here are continuous adjustments via actuators and discontinuous adjustments, i.e., incremental adjustments, involving mechanical solutions. In the mechanical adjustments, locks or latches are released or fixed for adjustment or latching purposes. This conventionally is accomplished by means of a lever, with which a force is transferred to an adjustable fitting. The force is here transferred proportionally, i.e., a force to be transferred rises with the lever stroke, or the torque increases with the twist angle during a rotational movement. The intermediate settings of the adjustable fittings already enable an adjustment with the adjustable fitting not quite unlocked. When adjusting between intermediate settings, undesirable side effects may come about, such as noise generation during adjustment or elevated wear. Levers for unlocking the locking device, and hence the adjustment device, usually rest directly on a rotational axis of the adjustment device. In order to prevent the backrest from spontaneously folding in the direction of the vehicle floor, and thus make it easier to adjust the backrest position, the known solutions exhibit a spring or the like. The spring acts in such a way as to pre-tension the backrest in a folding direction toward the seat part. In this case, the spring is preferably arranged in the area of the rotational axis between the seat part and backrest.

Known from DE 38 00 924 C2 is a vehicle seat with an adjustment device for a backrest, which consists of an immovable bearing block, and a swiveling arm that is pivoted to the bearing block, secured to the backrest, and can be fixed in optional angular settings by means of a locking device. The adjustment device is covered by a cover section in the direction toward the seat user. The bearing block is attached to the seat part, and the remaining parts of the adjustment device are arranged inside the backrest and joined thereto. The cover part is fixedly connected with a part of the adjustment device, and exhibits a slit into which an upwardly projecting area of the bearing block submerges when the backrest is folded forward.

The adjustment device is provided laterally to the outside on the motor vehicle, and thus takes up additional installation space.

Therefore, at least one object herein is to provide a solution that is less compact. In particular, at least one object herein is to provide a locking device, an adjustment device, a motor vehicle seat, a motor vehicle as well as a related method, in which a solution involving less installation space is realized. In addition, other objects, desirable features and characteristics will become apparent from the subsequent summary and detailed description, and the appended claims, taken in conjunction with the accompanying drawings and this background.

### SUMMARY

In an exemplary embodiment, a locking device for an adjustment device used to adjust a motor vehicle seat is provided. In particular, a locking device for a discontinuous adjustment device used to adjust a backrest position of the motor vehicle seat is provided. The locking device comprises an adjustable fitting joined by an adapter unit with the seat part and a backrest that can be adjusted, in particular folded, in relation to the seat part, so as to release and/or block an adjustment of the backrest relative to the seat part. A backrest force element interacts with the backrest in order to expose the backrest to a force at least with the adjustment device or locking device in an unlocked state. The backrest force element is arranged on and/or adjacent to an interior side, i.e., on a side of the locking device that does not face laterally outward.

The motor vehicle seat encompasses a backrest or (back)rest part and a seat part. The backrest and the seat part are adjustably connected with each other by an adjustment device. The adjustment device here exhibits a rotational axis, around which the backrest can be pivoted or folded relative to the seat part, so that an angle can be adjusted as desired by the user between the seat part and backrest. In order to latch the backrest into a desired position, the adjustment device exhibits a locking device. A locking device is preferably provided on each respective side of the motor vehicle seat or adjustment device.

The backrest or backrest part is adjusted by applying a force to the backrest. The backrest is here, for example, pre-tensioned, so that a pre-tensioning force acts in the direction of an upright seat position and against a back-swiveled position. In order to swivel the backrest, a force, for example, is applied by a user sitting on the seat, preferably by leaning or pressing against the backrest. To prevent an inadvertent adjustment of the backrest, the adjustment device encompasses the locking device as an interlock or latch, which prevents the inadvertent adjustment. In an embodiment, the locking device is configured as an adjustable fitting unit, in which two adjustable fitting parts interact. These are unlocked for adjustment purposes, so that the seat can be adjusted. The adjustment device encompasses the adjustable fitting unit. The two adjustable fitting parts are engaged in a locked state. In order to permit an adjustment, the adjustable fitting parts are moved apart, so as no longer to be engaged. The force or movement required for this purpose is imparted by way of a force transfer device. The two adjustable fitting parts are realized in such a way as to provide different intermediate settings between the two end positions or end states—locked and released—while moving them apart.

While adjustment is possible in some of these intermediate positions, the adjustable fitting parts are still slightly engaged. The force transfer device is provided to move the adjustable fitting parts apart, and can be used to transfer a locking and unlocking force at least to the adjustable fitting unit. The force here correspondingly results in a relative movement of the adjustable fitting parts. A force conversion device is provided so as to utilize a force transferred to the adjustable fitting unit via the force transfer device in such a way that an adjustment only takes place once the adjustable fitting parts have moved completely apart. The force transfer device is configured to implement the state in which the adjustable fitting parts are completely removed from each other and an adjustment is to be performed without contact between the adjustable fitting parts more rapidly and with a tangible feedback to the user.

In an embodiment, the locking device is situated in the area of the two ends of the rotational axis, which for example is formed by a transfer unit. The transfer unit is configured as a rotational axis, with which the backrest can be rotatably adjusted in relation to the seat part. To lock or release the rotation or folding of the backseat toward the seat part, the locking device encompasses an adjustable fitting. In order to prevent the backrest from inadvertently falling backward with the adjustable fittings released, a backrest force element is provided. When the locking device is released, the backrest force element exerts a force on the backrest, so that the latter does not fold down backward, but rather is pre-tensioned in a folding direction toward the seat part. The backrest force element is arranged in the area of the transfer unit. According to an embodiment, the backrest force element is situated on an interior side of the locking device. In this way, the entire locking device takes up less installation space at the very least axially, i.e., in an extension direction of the transfer unit, or even to the side or laterally. Accordingly, the same panel as for a continuous adjustable fitting can be used for the adjustment device with discontinuous adjustable fitting. One or several backrest force elements can be provided. The backrest force element is coupled directly with a backrest in one embodiment. In another embodiment, the backrest force element is indirectly coupled with the backrest, for example by way of an adapter, an adapter unit or the like. The backrest force element is not situated on or adjacent to an outwardly facing side, i.e., on a laterally outwardly facing side. Instead, the backrest force element is located on and/or adjacent to an interior side.

One embodiment provides that the backrest force element be arranged on an interior side of the adapter unit. In order to secure the locking device to the motor vehicle seat, the locking device exhibits an adapter unit. The adapter unit preferably encompasses an upper adapter element or adapter part, which is coupled with the backrest. In an embodiment, the adapter unit exhibits a lower or seat adapter element. This lower adapter element couples the locking device with the seat part. The adapter elements are coupled with each other so as to be rotatable around the rotational axis, so that the backrest can be made to fold in relation to the seat part by the adapter unit. In an embodiment, the backrest force element acts in conjunction with at least one adapter element. This causes a force to act in proximity to the transfer unit. The backrest force element is preferably formed on the interior side of the adapter unit, so that the latter does not outwardly protrude from the locking device. The backrest force element is preferably accommodated on the interior side of the upper adapter element.

A further embodiment provides that the adapter unit exhibit an upper adapter element or backrest adapter element, which is joined with the backrest and adjustable fitting. The backrest adapter element or upper adapter element is coupled with the backrest.

In addition, an embodiment provides that the adapter unit exhibit a lower adapter element or seat part adapter element, which is joined with the adjustable fitting and seat part. The seat part adapter element or lower adapter element is coupled with the seat part. The backrest force element acts in conjunction with the backrest adapter element and/or seat part adapter element.

Yet another embodiment provides that the backrest force element exhibit a spring accumulator unit. In an embodiment, the backrest force element is configured as a spring accumulator unit. The spring accumulator unit is preferably configured as a torsion spring, spiral spring or the like.

Still one other embodiment provides that at least one part and/or one end of the spring accumulator unit be secured to the backrest adapter element or upper adapter element. In order to interact with the backrest, at least one end of the spring accumulator unit is fixed to the backrest adapter element. Accordingly, the spring accumulator unit moves in conjunction with movement by the backrest or backrest adapter element. Fixation takes place with corresponding fasteners.

An embodiment also provides that at least another part or another end of the spring accumulator unit be fixed to the seat part and/or seat part adapter element or the lower adapter element. In this way, the spring accumulator unit is also fixed to the seat part. The seat part is secured in a rotationally fixed manner in one embodiment, at least in relation to the rotational axis, so that the seat part or seat part adapter element or lower adapter element serves as a support or locating bearing for the backrest force element or spring accumulator unit.

In another embodiment, a corresponding part of the spring accumulator unit exhibits a connecting element for fixation purposes. A connecting element is provided to realize a suitable connection with the adapter elements or backrest and/or seat part. For example, the connecting element is configured as a hook or the like. A connecting element, for example, is configured as an inner or central hook. The latter is joined with the upper adapter and/or backrest. To this end, the backrest and/or upper adapter exhibits a corresponding fastener. The backrest and/or adapter preferably exhibits a projection, a recess or the like, in which the central hook can engage. The spring accumulator unit, for example, is configured as a spiral spring. The inner or central end of the spiral spring exhibits the inner or central hook. As a consequence, the spring envelops the movable end of the spiral spring or connecting element of the backrest or upper adapter that moves during adjustment. The outer end of the spiral spring exhibits the outer hook or outer connecting element. The latter is fixed to a corresponding fastener of the lower adapter of seat part. This end preferably does not move when the motor vehicle seat is being adjusted.

In another embodiment, an adjustment device for adjusting a motor vehicle seat is provided. In particular a discontinuous adjustment device for adjusting a backrest position of the motor vehicle is provided. The adjustment device comprises at least two locks spaced axially apart. At least one of the locks is configured as a locking device as described above.

An embodiment provides that a backrest force element is arranged on a side facing the respective other locking device, in particular between the locking devices. Accordingly, the adjustment device exhibits two locking devices configured mirror-symmetrically to each other.

In an embodiment, the adjustment device exhibits two locking devices, one on each side of the motor vehicle seat. The locking devices each exhibit a separate locking mechanism. In order to synchronously unlock the adjustment device, the locking devices are interconnected. The interconnection has a parallel configuration in one embodiment. The locking devices are preferably serially connected. In addition, a corresponding synchronization is required for synchronously opening the locking devices.

One embodiment provides that each locking device exhibit a lever unit with which the locking device can be activated. The lever unit is arranged in a torque-proof manner on a rotational axis of the locking device. When the lever unit is activated, i.e., rotated, the rotational axis rotates too, and the locking device is unlocked, so that the backrest or backrest part can be adjusted.

Another embodiment provides that one of the lever units is coupled with the actuating device. In order to operate the locking devices by way of an actuating device or actuating unit, one of the locking devices is joined with the operating or actuating device, for example via a lever unit. In an embodiment, the operating unit is joined with the lever unit via a tension element. The tension element is configured as a rope-like element, in particular as a Bowden cable. The lever unit preferably exhibits an additional lever arm for connection with the operating unit. A conversion to the operating unit can be set via the second or additional lever arm. As a result, the operating unit can be situated a distance away from the rotational axis of the locking device, thus making the adjustment device remote controlled in design. In an embodiment, the adjustment device is situated at least partially at a readily accessible location remote from the rotational axis or the seat or the backrest. The remote-controlled adjustment device is preferably located in an area readily accessible to a user sitting on the seat, in particular within reach of the hands. All locking devices can be actuated via the one operating unit. Since the different locking devices are connected in series, one locking characteristic of the individual locking characteristics is superposed on the operating unit. In this case, the superposition is configured or the individual locking characteristics are configured in such a way as to yield a degressive force-distance progression on the operating unit.

In particular, the force-distance progression is not linear and/or not proportional, but rather preferably degressive or progressive in design. The individual lever units can here be configured in such a way that a force-distance progression kinks downward at the time the adjustable fitting parts are decoupled, meaning that a force to be applied for continued movement becomes smaller, thereby yielding a smoother running operating unit.

Another embodiment provides that at least one of the lever units encompasses a pivoted lever that can turn around a rotational axis, which permits the transfer of a force, in particular a torque. A simple force conversion device or force transfer device is realized in this way. In particular, a force transfer device and force conversion device are realized in a single component. An embodiment provides in particular that the force conversion device be integrated into the force transfer device.

In a further embodiment, a motor vehicle seat, in particular a motor vehicle seat with a backrest that can be adjusted relative to a seat part, encompasses an adjustment mechanism for adjusting the backrest. The adjustment mechanism is configured as an adjustment device of the kind described above. The motor vehicle seat is configured as a single seat in one embodiment. In another embodiment, the motor vehicle seat is configured as a seat bench. The seat bench exhibits split backrests in one embodiment, which can be adjusted separately and/or together by an adjustment device described above.

In yet another embodiment, a motor vehicle, in particular a passenger car, encompasses a seat arrangement for a vehicle passenger. The seat arrangement is configured as a motor vehicle seat of the kind described above. For example, the motor vehicle is designed as a sedan, station wagon, coupe, all-terrain vehicle, (mini)bus or the like.

Not least, a method for manufacturing a locking device, in particular a locking device as described above, encompasses the step of arranging a backrest force element on the locking device. The backrest force element is arranged on an interior side of the locking device.

Two spaced apart locking devices of an adjustment device are coupled with an adjustable fitting and/or the transfer unit. A backrest force element is provided to facilitate adjustment for a user. The backrest force element is coupled with the upper adapter and/or backrest. To this end, a free end of the backrest force element configured as a spiral spring is coupled with the upper adapter or backrest. Coupling takes place via corresponding fasteners. The spiral spring is provided, for example, with an inner or central hook element. The backrest and/or upper adapter is provided with a corresponding fastener, for example a recess, a projection and the like. The inner hook element is coupled with the corresponding fastener. The other end of the spiral spring is fixed to the lower adapter and/or seat part. For example, an outer hook element is provided on the spring for this purpose. The seat part and/or lower adapter exhibit a corresponding recess or a projection. Since the seat part and/or lower adapter element are preferably not moved during adjustment, the spring is fixed at this end, which preferably lies on the outside. In an embodiment, the spiral spring is arranged around a rotational axis, i.e., envelops the periphery of the rotational axis or transfer unit.

### BRIEF DESCRIPTION OF THE DRAWINGS

The various embodiments will hereinafter be described in conjunction with the following drawing figures, wherein like numerals denote like elements, and wherein:

FIG. 1 is a schematic, perspective view of part of a bearing structure for a motor vehicle seat, with an adjustment device having two locking devices, in accordance with an exemplary embodiment;

FIG. 2 is a schematic, front view of a section of the adjustment device according to FIG. 1;

FIG. 3 is a schematic, magnified perspective view of a section of the locking device with backrest force element;

FIG. 4 is another schematic, magnified perspective view of the locking device in accordance with an exemplary embodiment;

FIG. 5 is another schematic, perspective view of the locking device with backrest force element and two adapter elements in accordance with an exemplary embodiment;

FIG. 6 is the schematic view according to FIG. 5 without backrest force element;

FIG. 7 is a schematic, perspective view of an embodiment of the backrest force element in accordance with an exemplary embodiment;

FIG. 8 is a schematic, perspective view of backrest force element fasteners in accordance with an exemplary embodiment;

FIG. 9 is a schematic diagram of an embodiment for a connection between the hook element and corresponding adapter element; and

FIG. 10 is a schematic diagram of another embodiment for a connection between the hook element and corresponding adapter element.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

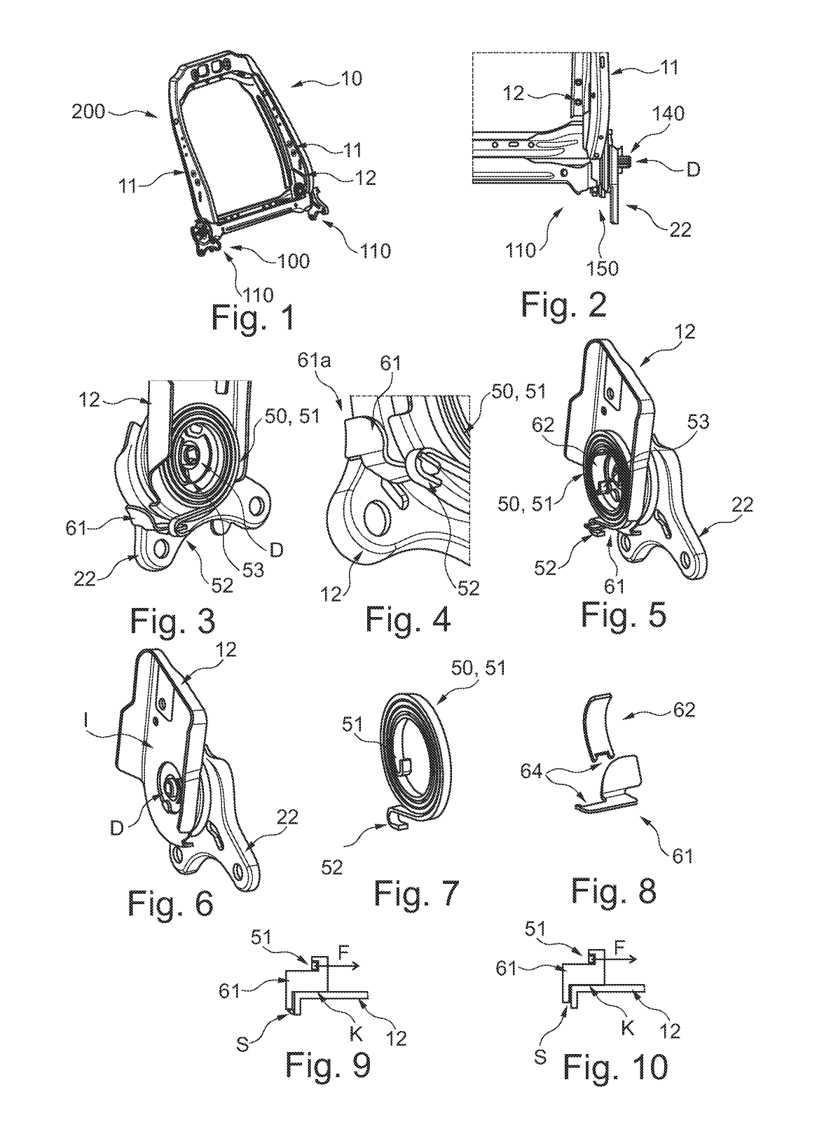

FIGS. 1 to 10 present different views of an embodiment for an adjustment device 100 in varying levels of detail.

In an exemplary embodiment, the adjustment device 100 connects a backrest part, or more generally a backrest 10, of a motor vehicle seat 200 with a seat part of the motor vehicle seat 200 not shown here in any greater detail. Only the bearing structure of the backrest 10 is here depicted. The backrest 10 and seat part are here foldably joined with or to each other via the adjustment device 100. The backrest 10 exhibits two backrest (part) sections 11 spaced laterally apart, which are coupled with the adjustment device 100. In the embodiment shown here, the backrest sections 11 are joined with the adjustment device 100 via adapter elements, the backrest adapter elements or upper adapter elements 12, which are described in greater detail below. The seat part is correspondingly joined with the adjustment device 100 on each seat partial section via a seat adapter element or lower adapter element 22. The adapter elements 12 and 22 comprise the adapter unit 25. Each side of the adjustment device 100 exhibits a locking device 110. The locking devices 110 are here mirror-inverted, and otherwise identical in design.

The locking devices 110 each encompass two adjustable fitting units, or more briefly adjustable fittings 150, which are engaged with each other when a lock has been established by the locking devices 110, and are correspondingly disengaged for unlocking the locking devices 110. The adjustment device 100 and locking device 110 will be described in greater detail below. Uniform reference numbers are used to denote identical or similar components. To provide a better overview, an extensive description has not been provided for already described components.

FIG. 1 presents a schematic, perspective view of part of a bearing structure for a motor vehicle seat 200 with an adjustment device 100 having two locking devices 110. The two laterally spaced apart locking devices 110 are mirror-symmetrical to each other, while otherwise exhibiting the same configuration. In order to activate both locking devices 110 simultaneously by a shared actuating unit or operating unit, and thereby activate the entire adjustment device 100 via the one shared operating unit, both locking devices 110 are coupled with each other, which is here not shown for reasons of clarity.

FIG. 2 presents a schematic, front view of a section of the adjustment device 100 according to FIG. 1. One side of the adjustment device 100 with the locking device 110 is depicted. The locking device 110 is joined with the backrest section 11 by the upper adapter element 12. The lower adapter element 22 is used to join the locking device 110 with the seat part. Here formed by a bar-shaped transfer unit 140, the rotational axis D can be locked or correspondingly released via the corresponding adjustable fitting 150. The adjustable fitting 150 is here configured as a discontinuous adjustable fitting 150. A backrest element 50 is formed on one interior side of the locking device 110, as described below.

FIG. 3 presents a schematic, magnified perspective view of a section of the locking device 110 with the backrest force element 50 according to an embodiment. The backrest force element 50 is arranged on an interior side of the locking device 110, more precisely on an interior side of the upper adapter element 12. The backrest force element 50 is configured as a spiral spring 51. The latter peripherally envelops the rotational axis D. The spiral spring 51 exhibits an outer, fixed end 52 and an inner, free end 53. The outer end 52 is immovably secured to the lower adapter element 22 via an outer hook element 61. To this end, the outer end 52 is bent by about 180°, thereby forming a U-shaped end. The spiral spring 51 uses this U-shaped end to interact with the hook element 61, and as a result is fixed to the lower adapter element 22. The inner end 53 is joined with an inner hook element 62. This inner hook element 62 connects the free end 53 with the upper adapter element 12. Accordingly, the free end 53 can move along with the upper adapter element 12.

FIG. 4 presents another schematic, magnified perspective view of the locking device 110 according to an embodiment. Depicted here is the connection between the outer end 52 of the spiral spring 51 with the lower adapter element 12 by way of the outer hook element 61. The outer end 52 is bent around a corresponding holding fixture of the outer hook element 61 with U-shaped bent end. The outer hook element 61 is bent at an angle of about 90°. The outer hook element 16 abuts against the lower adapter element 12 with the angularly projecting section. The outer hook element 61 here exhibits an angled end 61a, with which the hook element 61 envelops the lower adapter element 12, and can thereby be fixed to the lower adapter element 12. In addition, a firmly bonded connecting element is preferably provided.

FIG. 5 presents another schematic, perspective view of the locking device 110 with the backrest force element 50 and the two adapter elements 12 and 22 in accordance with an embodiment. The backrest force element 50 is designed as a spiral spring 51, and arranged on an interior side of the locking device 110, more precisely on an interior side of the upper adapter element 12. The U-shaped end 52 of the spiral spring 51 is connected by way of the outer hook element 61 with the lower adapter element 22, and thereby fixed in place. The other end of the spiral spring 51 is joined with the upper adapter element 12 via the inner hook element 62. The inner or free end 53 of the spiral spring also has a U-shape for connection with the inner hook element 62.

FIG. 6 presents the schematic view according to FIG. 5 without the backrest force element 50. The two adapter elements 12, 22 are joined with each other so that they can rotate around the rotational axis D by the adjustable fitting 150. The upper adapter element 12 exhibits an interior side I, which is configured to accommodate the backrest force element 50.

FIG. 7 presents a schematic, perspective view of an embodiment of the backrest force element 50. The backrest force element 50 is configured as a spiral spring 51. The spiral spring 51 exhibits two ends 52 and 53, which are each U-shaped. The inner end 53 exhibits an inwardly bent, U-shaped end 53. The outer end 52 exhibits an outwardly bent, U-shaped end 52. As a whole, the spiral spring 51 consists of about four windings, which run peripherally around the rotational axis D. The windings or turns run in a plane, thus making the spiral spring 51 compact.

FIG. 8 presents a schematic view of fasteners 60 for the backrest force element 50 in accordance with an embodiment. As described above, the fasteners 60 are configured as hook elements 61, 62, specifically as an outer hook element 61 and an inner hook element 62. The inner hook element 62 is slightly curved, with a recess 64 for the inner end 53 of the spiral spring 51. The outer hook element 61 is angled, also with a recess 64 for the outer end 52 of the spiral spring 51. In addition, the outer hook element 61 is angled, so as to abut against the lower adapter element 22, and at least partially envelop the latter.

FIG. 9 presents a schematic diagram of an embodiment for a connection between the hook element 61 and the corresponding adapter element 22. The spiral spring 51 is incorporated into the recess 64 of the hook element 61. The hook element 61 is angled, and abuts against two sides of the adapter element 22. An optimized distribution of force is realized over the contact surface K formed in this way. The outer hook element 61 is welded to the lower adapter element 22 at one end, for example via arc welding. The load placed on the welded seam S is reduced by the contact or contact surface K between the hook element 61 and the lower adapter element 22. The spring force F is also recorded at F. The angled design of the outer hook element 61 ensures an optimal distribution of force.

FIG. 10 presents a schematic diagram of another connection between the hook element 61 and the corresponding adapter element 22 in accordance with another embodiment. The embodiment differs from the embodiment according to FIG. 9 by the type of welding. As opposed to FIG. 9, the connection is not realized via arc welding, but rather via laser welding.

As a consequence, the various embodiments herein allow the realization of a compact adjustment device 100. The locking device 110 and adjustment device 100 exhibit a slender design. The arrangement of the backrest force element 50 makes it possible to use the same lining or lateral outer cover panels for continuous and discontinuous adjustment devices 100. The additional installation space gained in this way permits a better integration of the actuating levers for the adjustable fittings 150. The inner arrangement of the respective backrest force element 50 also allow the connecting elements 60 to move on the interior side I, so that this does not influence the lateral outer cover panel.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A locking device for an adjustment device for adjusting a motor vehicle seat, the locking device comprising:
an adjustable fitting;
an adapter unit that joins the adjustable fitting with a seat part and a backrest that is adjustable in relation to the seat part so as to release and/or block an adjustment of the backrest relative to the seat part;
a backrest force element that interacts with the backrest to expose the backrest to a force at least with the locking device in an unlocked state, wherein the backrest force element is arranged on an interior side of the locking device.

2. The locking device according to claim 1, wherein the adjustment device is a discontinuous adjustment device for adjusting a backrest seat position of the motor vehicle seat.

3. The locking device according to claim 1, wherein the backrest is foldable in relation to the seat part.

4. The locking device according to claim 1, wherein the backrest force element is situated on an interior side of the adapter unit.

5. The locking device according to claim 1, wherein the adapter unit comprises an upper adapter element that is joined with the backrest and the adjustable fitting.

6. The locking device according to claim 1, wherein the adapter unit comprises a lower adapter element that is joined with the adjustable fitting and the seat part.

7. The locking device according to claim 1, wherein the backrest force element comprises a spring accumulator unit.

8. The locking device according to claim 7, wherein at least one part of the spring accumulator unit is secured to an upper adapter element.

9. The locking device according to claim 8, wherein at least another part of the spring accumulator unit is fixed to the seat part and/or a lower adapter element.

10. The locking device according to claim 9, wherein a corresponding part of the spring accumulator unit comprises a connecting element for fixation purposes.

11. An adjustment device for adjusting a motor vehicle seat, the adjustment device having at least two locking devices spaced axially apart, wherein at least one of the at least two locking devices comprises:
an adjustable fitting;
an adapter unit that joins the adjustable fitting with a seat part and a backrest that is adjustable in relation to the seat part so as to release and/or block an adjustment of the backrest relative to the seat part; and
a backrest force element that interacts with the backrest to expose the backrest to a force at least with the at least one of the at least two locking devices in an unlocked state, wherein the backrest force element is arranged on an interior side of the at least one of the at least two locking device.

12. The adjustment device according to claim 11, wherein the adjustment device is a discontinuous adjustment device for adjusting a backrest position of the motor vehicle seat.

13. The adjustment device according to claim 11, wherein the backrest force element is arranged on a side facing the respective other of the at least two locking devices.

14. The adjustment device according to claim 13, wherein the backrest force element is arranged between the at least two locking devices.

15. A motor vehicle seat with a backrest that can be adjusted relative to a seat part, the motor vehicle seat having an adjustment mechanism for adjusting the backrest, wherein the adjustment mechanism is configured as an adjustment device with at least two locking devices spaced axially apart, wherein at least one of the at least two locking devices comprises:
an adjustable fitting;
an adapter unit that joins the adjustable fitting with the seat part and the backrest that is adjustable in relation to the seat part so as to release and/or block an adjustment of the backrest relative to the seat part; and
a backrest force element that interacts with the backrest to expose the backrest to a force at least with the at least one of the at least two locking devices in an unlocked state, wherein the backrest force element is arranged on an interior side of the at least one of the at least two locking device.

16. A motor vehicle with a seat arrangement for a vehicle passenger, wherein the seat arrangement has a backrest that can be adjusted relative to a seat part, the seat arrangement having an adjustment mechanism for adjusting the backrest, wherein the adjustment mechanism is configured as an adjustment device with at least two locking devices spaced axially apart, wherein at least one of the at least two locking devices comprises:
an adjustable fitting;
an adapter unit that joins the adjustable fitting with the seat part and the backrest that is adjustable in relation to the seat part so as to release and/or block an adjustment of the backrest relative to the seat part; and
a backrest force element that interacts with the backrest to expose the backrest to a force at least with the at least one of the at least two locking device in an unlocked state, wherein the backrest force element is arranged on an interior side of the at least one of the at least two locking device.

17. The motor vehicle according to claim 16, wherein the motor vehicle is a passenger car.

18. A method for manufacturing a locking device for an adjustment device for adjusting a motor vehicle seat, wherein the locking device has an adjustable fitting and an adapter unit that joins the adjustable fitting with a seat part and a backrest of the motor vehicle seat, the backrest adjustable in relation to the seat part, so as to release and/or block an adjustment of the backrest relative to the seat part, the method comprising the steps of:
arranging a backrest force element on an interior side of the locking device, wherein the backrest force element interacts with the backrest to expose the backrest to a force at least with the locking device in an unlocked state.
